(19) United States
(12) Patent Application Publication
(10) Pub. No.: US 2019/0180319 A1
(43) Pub. Date: Jun. 13, 2019

(54) METHODS AND SYSTEMS FOR USING A GAMING ENGINE TO OPTIMIZE LIFETIME VALUE OF GAME PLAYERS WITH ADVERTISING AND IN-APP PURCHASING

(71) Applicant: Unity IPR ApS, Copenhagen K (DK)

(72) Inventors: Sampsa Valtteri Jaatinen, San Francisco, CA (US); Stephen Michael Sullivan, San Francisco, CA (US)

(21) Appl. No.: 16/218,165

(22) Filed: Dec. 12, 2018

Related U.S. Application Data
(60) Provisional application No. 62/598,258, filed on Dec. 13, 2017.

(51) Int. Cl. G06Q 30/02; A63F 13/61; G06N 20/20

(52) U.S. Cl. CPC G06Q 30/0247; G06Q 30/0275; G06N 20/20; A63F 13/61; G06Q 30/0276

(57) ABSTRACT

A method for optimizing LTV related to cumulative future rewards for a player of a plurality of computer-implemented games is disclosed. Data is collected from a game of the plurality of games. The data includes game event data associated with the player, a playing environment within the game, and engine actions performable by the LTV module. The data is analyzed with a first machine-learning (ML) system to create a time-dependent state representation of the game, the player, and the playing environment. The state representation is provided as input to a second ML system to create and optimize an ML policy over time. The ML policy includes a functional relationship proposing a selection of one or more of the engine actions to maximize the LTV. The ML policy and state representation is provided to an LTV optimization module to choose and implement one or more of the engine actions.

### CROSS REFERENCE TO RELATED APPLICATIONS

This application claims the benefit of U.S. Provisional Application No. 62/598,258, filed Dec. 13, 2017, which is incorporated by reference herein in its entirety.

### TECHNICAL FIELD

The present invention relates to the field of machine learning and, in one specific example, to machine learning for advertising and in-app purchases within video games.

### BACKGROUND OF THE INVENTION

The current methods and systems for advertising and in-application (in-app) purchases in the game industry are static due to the fact that they use manual coding and fixed logic to determine specific ads and purchases visible to a user. Current implementations use the concept of placement (or location) to have a developer explicitly define where (e.g., location within a game environment) to show a server configured promotion. To do this the developer writes code that displays a promotion during a game by, for example, showing client-side art or retrieving a promotional asset from a server. The number of possible defined placements is usually 1-3 and any change to the number or location of placements in a game requires a new version of a game (or application). Traditional methods pick one moment in a game and show a similar promotion to all users.

### BRIEF DESCRIPTION OF THE DRAWINGS

Further features and advantages of the present invention will become apparent from the following detailed description, taken in combination with the appended drawings, in which:

FIG. 1 is a schematic illustrating a “lifetime value” (or LTV) optimization system, in accordance with one embodiment;

FIG. 2 is a flowchart illustrating a method for LTV optimization, in accordance with one embodiment;

FIG. 3 is a schematic illustrating a data flow diagram of the LTV optimization system, in accordance with one embodiment;

FIG. 4 is a block diagram illustrating an example software architecture, which may be used in conjunction with various hardware architectures described herein; and

FIG. 5 is a block diagram illustrating components of a machine, according to some example embodiments, configured to read instructions from a machine-readable medium (e.g., a machine-readable storage medium) and perform any one or more of the methodologies discussed herein.

It will be noted that throughout the appended drawings, like features are identified by like reference numerals.

### DETAILED DESCRIPTION

The description that follows describes systems, methods, techniques, instruction sequences, and computing machine program products that constitute illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details.

A method for optimizing LTV related to cumulative future rewards for a player of a plurality of computer-implemented games is disclosed. Data is collected from a game of the plurality of games. The data includes game event data associated with the player, a playing environment within the game, and engine actions performable by a LTV module. The engine actions include advertisement placements and in-app purchase (IAP) placements within the game. The data is analyzed with a first machine-learning (ML) system to create a time-dependent state representation of the game, the player, and the playing environment. The state representation is provided as input to a second ML system to create and optimize an ML policy over time. The ML policy includes a functional relationship proposing a selection of one or more of the engine actions to maximize the LTV. The ML policy and state representation is provided to an LTV optimization module to choose and implement one or more of the engine actions from the proposed selection within the playing environment.

The methods and systems described herein may use machine learning to maximize the total income that a game developer can earn from an audience base with respect to both advertising and in-app purchasing by dynamically placing promotions (in time and space) so that any moment in the game can contain a promotion and a user can see the promotion at an optimal time in their life cycle. The income (e.g., also referred to herein as revenue) includes cash, credit, debit, and virtual money in any currency. More specifically, the systems and methods work to maximize the revenue per player.

Throughout the description herein, the term total revenue per player is taken to include the sum of all money from events where actions of a game player bring income to a game developer; the actions including in application (in-app) purchases (or IAPs) made by the game player, and paid advertisements viewed by the game player. In accordance with some embodiments, the total revenue generated per player is also referred to as the LTV of a player.

Turning now to the drawings, systems and methods for optimizing LTV of a game player in accordance with embodiments of the invention are illustrated. The methods and systems described herein maximize LTV by optimizing the use of monetization placements (e.g., in time and space) in a game; and also maximizing the total number of monetization placements seen by a player by maximizing the time a player is engaged with a game (e.g., maximizing total play time). The LTV optimization occurs for an individual game player (e.g., in contrast to optimizing for segments or cohorts of players). The methods and systems herein include optimization from advertisement revenue sources and optimization from IAP revenue sources concurrently. The systems and methods herein determine dynamically whether it is optimum (e.g. at a given time and place within a game) to use an advertisement and/or an IAP.

In accordance with an embodiment, the term monetization placements used herein refers to the placement within a game of advertisements and in-app purchases, the placements being specific to time and location (e.g., a monetization placement can be shown at a specific time during the game and at a specific location in the game play environment; wherein the specifics are determined dynamically by the methods and systems herein).

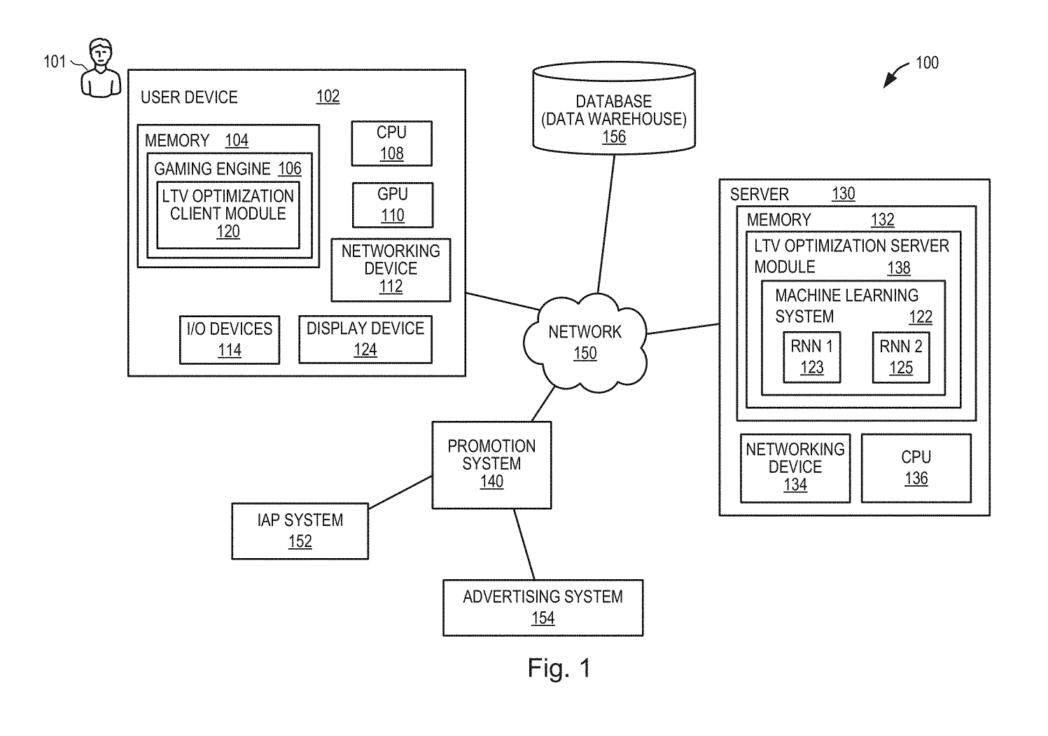

In accordance with an embodiment, FIG. 1 is a schematic showing an example LTV optimization system 100 and associated devices configured to provide LTV optimization for a game player. In the example embodiment, the LTV optimization system 100 includes a user device 102 operated by a user 101, a server 130, a database 156, and a promotion serving system 140, all coupled in networked communication via a network 150 (e.g., a cellular network, a Wi-Fi network, the Internet, a wired local network, and the like). The user device 102 is a computing device capable of providing a gameplay experience (e.g., a game, including video games) to the user 101. In some embodiments, the user device 102 is a mobile computing device, such as a smartphone, a tablet computer and a head mounted display (HMD) device (e.g., including virtual reality HMDs and augmented reality HMDs). In other embodiments the user device 102 is a desktop computer or game console. The game provided to the user can be any type of video game including 2 dimensional (2D) games, 3-dimensional (3D) games, virtual reality (VR) games, augmented reality (AR) games and the like. Although not separately shown in FIG. 1, in practice the system 100 would have a plurality of user devices connected to the network.

In the example embodiment, the user device 102 includes one or more central processing units (CPUs) 108, and graphics processing units (GPUs) 110. The user device 102 also includes one or more networking devices 112 (e.g., wired or wireless network adapters) for communicating across the network 150. The user device 102 also includes one or more input devices 114 such as, for example, a keyboard or keypad, mouse, joystick (or other game play device), pointing device, touch screen, or handheld device (e.g., hand motion tracking device). The user device 102 further includes one or more display devices 124, such as a touchscreen of a tablet or smartphone, or lenses or visor of a VR or AR HMD, which may be configured to display virtual objects to the user 101 in conjunction with a real-world view. The display device 124 is driven or controlled by the one or more GPUs 110. The GPU 110 processes aspects of graphical output that assists in speeding up rendering of output through the display device 124.

The user device 102 also includes a memory 104 configured to store a game engine 106 (e.g., executed by the CPU 108 or GPU 110) that communicates with the display device 124 and also with other hardware such as the input device(s) 114 to present a game to the user 101. The game engine 106 includes a LTV optimization client module (“client module”) 120 that provides various LTV optimization functionality as described herein. Each of the LTV optimization client module 120, and game engine 106 include computer-executable instructions residing in the memory 104 that are executed by the CPU 108 or the GPU 110 during operation. The LTV optimization client module 120 may be integrated directly within the game engine 106 or may be implemented as an external piece of software (e.g., a plugin).

In accordance with an embodiment, the server 130 includes a CPU 136 and a networking device 134 for communicating across the network 150. The server 130 also includes a memory 132 for storing a LTV optimization server module (“server module”) 138 that provides various LTV optimization functionality as described herein. The LTV optimization server module 138 includes computer-executable instructions residing in the memory 132 that are executed by the CPU 136 during operation. The memory 132 includes a machine learning system 122 that includes a first recurrent neural network (RNN-1) 123, and a second recurrent neural network (RNN-2) 125 which are implemented within, or otherwise in communication with, the LTV optimization server module 138. In accordance with some embodiments, the neural network architecture for RNN-1 123 can be a fully connected feed forward network using rectifier linear units or logistic units or a combination thereof. The neural network RNN-1 123 can also assume a form of recurrent neural network employing long short-term memory units (LS™), gated recurrent unit (GRU) or equivalent. Similarly, the neural network architecture for RNN-2 125 can be a fully connected feed forward network using rectifier linear units or logistic units or a combination thereof. The neural network RNN-2 125 can also assume a form of recurrent neural network employing long short-term memory units (LSTM), gated recurrent unit (GRU) or equivalent. In still other embodiments, the recurrent neural networks (RNN-1 123 and RNN-2 125) can be replaced by any other type of machine learning system and neural network with memory. During operation, the LTV optimization client module 120 and the LTV optimization server module 138 perform the various LTV optimization functionalities described herein. More specifically, in some embodiments, some functionality may be implemented within the client module 120 and other functionality may be implemented within the server module 138. For example, the client module 120, executing on the user device 102, may be configured to monitor the game play environment to measure interactions of the user 101 with the game environment and may also be configured to dynamically insert monetization placements within the game play environment. The server module 138, executing on the server device 130, may be configured to analyze data from the client module 120 in order to determine specific IAP purchases (e.g., from the IAP system 152) and ads (e.g., from the advertising system 154) to include within the monetization placements sent to the client module 120 to be displayed to the user.

In accordance with some embodiments the LTV optimization system 100 includes a promotion system 140 that can include or communicate with an advertising system 154 and an IAP system 152. The advertising system 154 allows advertising entities to make advertisements available for an auction while the IAP system 152 allows IAP entities to make IAP purchases available for the auction. An advertising entity is any group, company, organization or the like that provides advertisements to the advertising system (e.g., including game production studios, movie production studios, car manufacturers, software companies, and more). An TAP entity is any group, company, organization of the like that provides in-app purchases to the TAP system (e.g., including game production studios, movie production studios, software companies, and more). In some embodiments, a group, company, organization or the like may be both a advertising entity and a TAP entity.

In accordance with an embodiment, throughout the description herein, interactions between the user 101 and game environment and game logic are referred to as game events. The game events include events related to the interaction of the user 101 with a user interface (UI) of the game application outside the playing environment (e.g., watching or skipping a cut-scene before or after a level, and opening a UI window for settings or high score, and the like). The game events include events related to the progress of a player through a game (e.g., including starting a game, starting a level of the game, completing a level of the game, losing a level of the game, quitting a level of the game, skipping a level of a game, increasing in rank or skill level in a game, and the like). The game events include events related to the first time user experience of the user (e.g., including completing any interaction after opening the game for the first time, and beginning a tutorial, and passing a milestone in a tutorial, and completing a tutorial and skipping a tutorial, and the like). The game events include events related to user retention and virality (e.g., including player enabling or responding to push notifications, a player sending chat messages, a player completing an achievement or a milestone towards an achievement such as killing an enemy or finding a secret room, a player connecting with and sharing on a social network, and the like). The game events include monetization events related to revenue (e.g., LTV) and the game economy, wherein the monetization events include purchasing a game asset within a game (e.g., a weapon, a character skin, a vehicle), purchasing a game, opening a store within a game, selecting an item in a store, spending real-world money, and includes any event wherein the user makes a purchase within a game. The monetization events also include ad-engagement events such as starting, finishing and skipping viewing of an advertisement within a digital in-game store, or gameplay environment. The monetization events include completing an action prompted by an advertisement. The underlying details for a game event is created in the game code by a game developer and can be customized to include specific events. In accordance with an embodiment, in order to maximize the effectiveness of the systems and methods described herein, it is expected that a developer include a plurality of specific game events in a game.

Throughout the description herein we refer to actions taken by the game engine (or potential actions the game engine can take in a future) as engine actions. In accordance with an embodiment, an engine action includes the process of showing a promotional item (e.g., an advertisement, a promotional offer, an IAP, and more) to a user 101 at a time and a place within a game. In accordance with an embodiment, engine actions include monetization placements. The engine actions include displaying an advertisement to a game player during game play and displaying in-app purchases to the game player during game play. An engine action can include information regarding the displaying of the content within the engine action, including the following: a display time, which describes the time at which the engine action starts; a display duration, which describes the duration over which the engine action is displayed; a display location, which describes the location (e.g. within the game environment) where the engine action is displayed; and a display format, which describes the format (e.g. visual format, or user interface) of the display of the engine action.

In accordance with an embodiment, throughout the description herein the term ‘reward’ will be used to refer to revenue received (e.g., by the developer) within a game or in connection with a game as a result of an engine action. Each engine action is associated with a reward (including a null reward whereby no revenue is received).

In accordance with an embodiment, RNN-2 125 creates an engine action policy (e.g., or just ‘policy’) for the LTV optimization server module 138 (or alternately for the LTV optimization client module 120). The policy includes information that describes a relationship (e.g., a mapping) between player states, game events, engine actions and rewards. The policy can include rules, heuristics, and probabilities for matching a player state (including game events) with one or more engine actions in order to maximize a future reward. The engine action policy is an output of RNN-2 125, and is used as a guide by the LTV optimization server module 138 (or alternately the LTV optimization client module 120) to decide on one or more engine actions to incorporate into a game given a particular user state and a context (e.g., a specific game environment with specific game events). The machine learning system 122 uses RNN-2 125 in a reinforcement learning scenario in order for RNN-2 125 to create the policy and then continuously update the policy based on user actions over time. RNN-2 125 learns a functional relationship between possible engine actions and cumulative future rewards.

Specific engine actions available to a game engine include a plurality of possible engine actions provided by the promotion system 140. The promotion system 140 is in communication with the LTV optimization server module 138 to provide access to data from the advertising system 154 and the IAP system 152 in order to provide an auctioning service that allows advertising entities and IAP entities (e.g., via the advertising system 154 and the IAP system 152) to bid on impressions of engine actions. An impression is a placeholder (e.g., open spot) for an engine action which can include location, time, and duration of the impression. An impression can be bid on by an advertising entity or an IAP entity. The advertising entities and IAP entities are on the demand side of the auction (e.g. they are bidding for impressions) and the LTV optimization server module 138 is on the supply side of the auction (e.g. providing engine action impressions that can be bid on). During operation of an auction, a demand entity sees an impression and submits a bid (e.g., monetary bid) to compete for the impression. The LTV optimization server module 138 receives bids from the promotion serving system 140 and chooses (e.g., using the engine action policy from the machine learning system 122) a bid that the engine action policy determines is the most beneficial at the moment of the reception of the bids. The receiving of the bids may have a time limit. After choosing a bid, the LTV optimization server module 138 requests from the promotion serving system 140 the data for the specific impression that won the bid. Once the LTV optimization server module 138 receives data for the impression, the module 138 uses the data to complete the engine action by placing the ad or IAP in the game according to the specific data within the impression. The server module 138 is not bound to choose the highest bid (e.g., largest monetary value), but rather the module 138 employs the engine action policy from RNN-2 125 to choose a bid whereby the choice is based on a prediction from RNN-2 125 that the choice will result in a maximized future potential LTV.

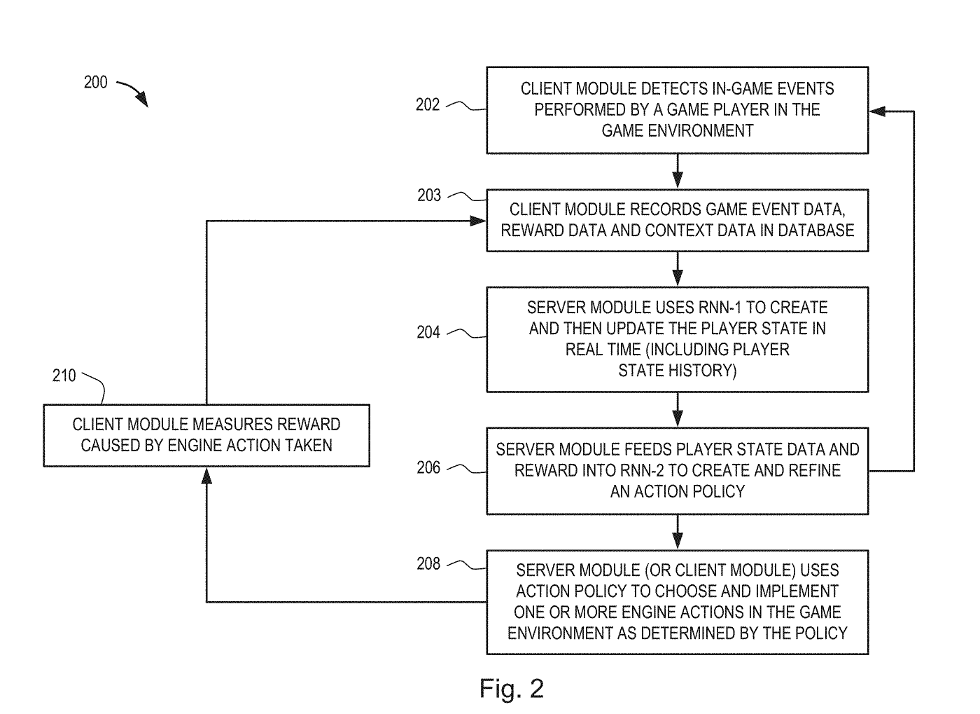

In accordance with an embodiment, FIG. 2 shows a flowchart for a method 200 for LTV optimization using the LTV optimization system 100. In reference to FIG. 2, during operation 202, the LTV optimization client module 120 detects game events (e.g., game event data) performed by a game player in the game environment (e.g. making in-game or in-app purchases, purchasing a second game while in a first game, finishing a level, etc.). The LTV optimization client module 120 also records all rewards generated by a player 101. In addition to the game event data, the client module 120 records data regarding context for the player 101, which includes information not related to the actions of a player 101. For example, context data includes: device type used by the player, day of the week played, time of the day played, country where game is played, title of the game, and the like. At operation 203 of the method 200, the game event data, reward data and context data are recorded by the client module 120 in the database 156. In accordance with an embodiment, there is provided a logging system (not separately shown in the Figures) to record the game event data reward data, and context data. At operation 204 of the method 200, the LTV optimization server module 138 communicates with the database 156 to extract the game event data, reward data, and context data for the game player 101. As part of operation 204, the LTV optimization server module 138 provides the data to RNN-1 123 which creates representations from the data. The representations can include a time dependent representation of a player state, which includes a representation for context data, and a representation for engine actions. The output of RNN-1 123 includes a numerical representation or description of a player state (which includes game environment data and engine action data) that is provided to RNN-2 125. The process of generating representations for the player state and reward data can include the use of natural language processing (NLP). For example, a NLP system can be used to analyze a text description of a game (e.g., as acquired from an application store) and generate a numerical representation of the description. Similarly, a NLP system or a neural network can be used to generate a numerical representation of a promotion asset (e.g., including advertisements and IAP) from the promotion system 140. The promotion assets might include multimedia such as images and videos which can be converted to numerical representations. In addition to machine learned representations, other non-machine learned numerical representations can be used (e.g., the number of times different events occur per time interval). As an example of operation 204, the LTV optimization server module 138 provides data to RNN-1 123 which uses the data to define a first state at a first time (e.g. state S(t) which changes over time (t)) for the game player 101. In some embodiments, the first state includes a history of previous game events recorded by the client module 120 for the player 101. For example, the first state could include the following time-ordered series of game events and context data:

Event 1) At time t1, player started game ‘A’
Event 2) At time t2, player watched ad ‘123’ in game ‘A’
Event 3) At time t3, player bought IAP item ‘ABC’ in game ‘A’
Event 4) At time t4, player ended game ‘A’
Event 5) At time t5, player started game ‘B’
Event 6) . . .

While the above is shown in text format for convenience, the data as produced by RNN-1 123 could be in numerical format. Referring back to FIG. 2, and in accordance with an embodiment, at operation 206 the server module 138 provides a player state (e.g., player state data from the output of RNN-1 123) and reward data into a machine learning system 122 that includes the second neural network RNN-2 125. The second neural network RNN-2 125 uses the state data from RNN-1 123 and the reward data to determine an engine action policy. At operation 208, the LTV optimization server module 138 uses the engine action policy and current state data (e.g., first state data) to choose one or more engine actions to be implemented in the game environment. The engine action policy is used by the LTV optimization server module 138 as a guide to make the optimum decision at each moment (e.g., in real-time), taking into account past events (e.g., previous player states and rewards) and future impacts (e.g., predicted changes in the player state and predicted future rewards). The decision includes the choice of engine actions to employ given a current user state and engine action policy. Using the method 200 to follow a single player, the LTV optimization server module 138 uses RNN-2 125 within the machine learning system 122 to learn over time an optimum engine action policy on a per player basis, not on player segments or other groupings of game players.

In accordance with an embodiment, during operation 208 of the method 200, the client module 120 implements the chosen engine action (e.g., places a specific advertisement within a game at a specific time and place) chosen by the server module 138 using the policy. In the embodiment, the client module 120 implements the decision made by the server module 138.

In accordance with another embodiment, during operation 208 of the method 200, the client module 120 uses the engine action policy and state data (e.g., the first state) to choose one or more engine actions, and to subsequently implement (e.g., place) the chosen one or more engine actions in the game environment. In the embodiment, the client module 120 both chooses and implements the engine action.

In accordance with an embodiment, at operation 210, as part of reinforcement learning with RNN-2 125, the client module 120 records the reward caused by the one or more chosen engine actions and feeds it back to RNN-2 (e.g. via the database 156).

In accordance with an embodiment the LTV optimization server module 138 uses a form of reinforcement learning (e.g. using RNN-2 125) at each decision-making point, to learn a policy connecting a player state, each engine action, future predicted rewards and predicted future player states. The LTV optimization server module 138 creates (e.g., via the recursion of reinforcement learning of RNN-2 125) an evolving engine action policy for a player so that over time a game (e.g., the developer of the game) receives the maximum amount of monetary rewards from the player. Furthermore, because of the use of the player state (e.g., with player state history) and RNN-1 123, which uses memory of past player states (e.g. using LSTM), the policy is optimized on an individual player level and in an ongoing and dynamic way (e.g., the policy determines the best set of engine actions with a specific individual user, at a specific time in a specific game context).

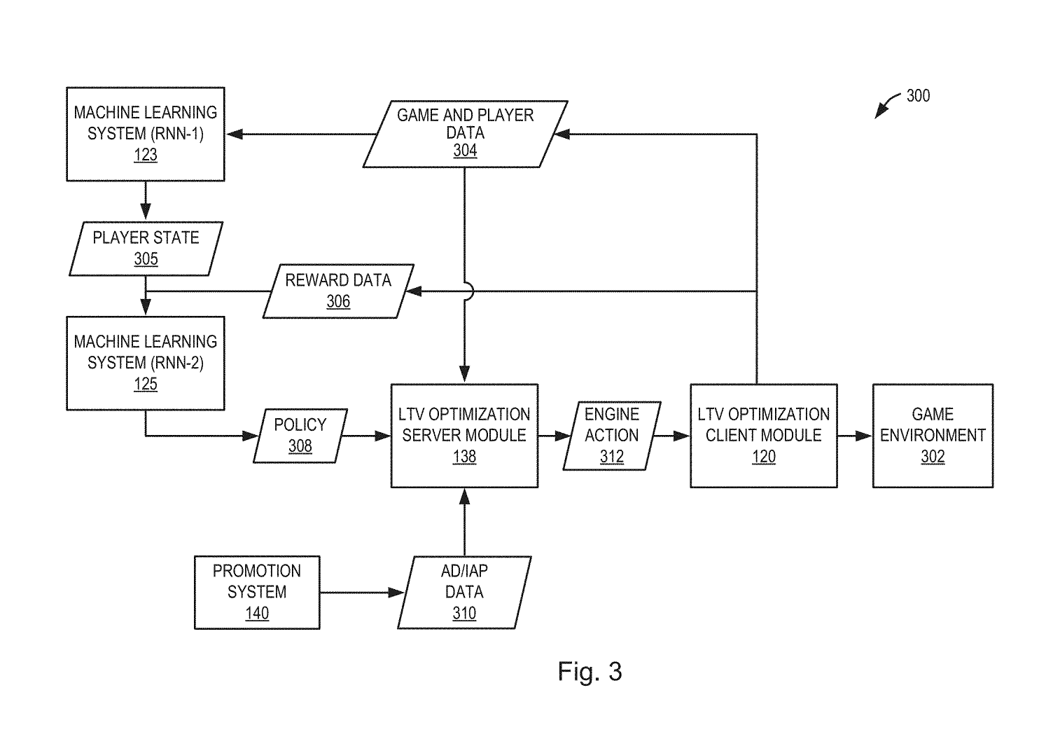

FIG. 3 is a data flow diagram for the LTV optimization system 100. Some elements of the system 100 (e.g. the database 156) are not shown. With reference to FIG. 3, the LTV optimization client module 120 monitors the game environment 302 in order to extract data 304 describing game events and context and data describing rewards 306. The extracted data 304 is provided to RNN-1 123 of the machine learning system 122 in order for RNN-1 123 to determine a player state 305. The state 305 and the reward data 306 are provided to RNN-2 125 of the machine learning system 122 to create and maintain a policy 308 for the server module 138. The LTV optimization server module 138 uses the policy 308 to make decisions on the content and placement of engine actions 312 in the game environment 302 (the placements of engine actions may be implemented by the client module 120). The decisions include selecting one or more advertising placements and/or IAP placements from the promotion system 140 (e.g., selecting specific ad/AIP data 310) to include in the one or more engine actions 312 that are sent to the client module 120 to be exposed to the user in the game environment 302. The decision process may include an auction for impressions. The ad/AIP data 310 includes bidding data, advertising data, and AIP data which can be used in the auction (e.g., within an impression).

While illustrated in the block diagrams as groups of discrete components communicating with each other via distinct data signal connections, it will be understood by those skilled in the art that the preferred embodiments are provided by a combination of hardware and software components, with some components being implemented by a given function or operation of a hardware or software system, and many of the data paths illustrated being implemented by data communication within a computer application or operating system. The structure illustrated is thus provided for efficiency of teaching the present preferred embodiment.

It should be noted that the present disclosure can be carried out as a method, can be embodied in a system, a computer readable medium or an electrical or electro-magnetic signal. The embodiments described above and illustrated in the accompanying drawings are intended to be exemplary only. It will be evident to those skilled in the art that modifications may be made without departing from this disclosure. Such modifications are considered as possible variants and lie within the scope of the disclosure.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or with any suitable combination thereof. For example, a hardware module may include dedicated circuitry or logic that is permanently configured to perform certain operations. For example, a hardware module may be a special-purpose processor, such as a field-programmable gate array (FPGA) or an Application Specific Integrated Circuit (ASIC). A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

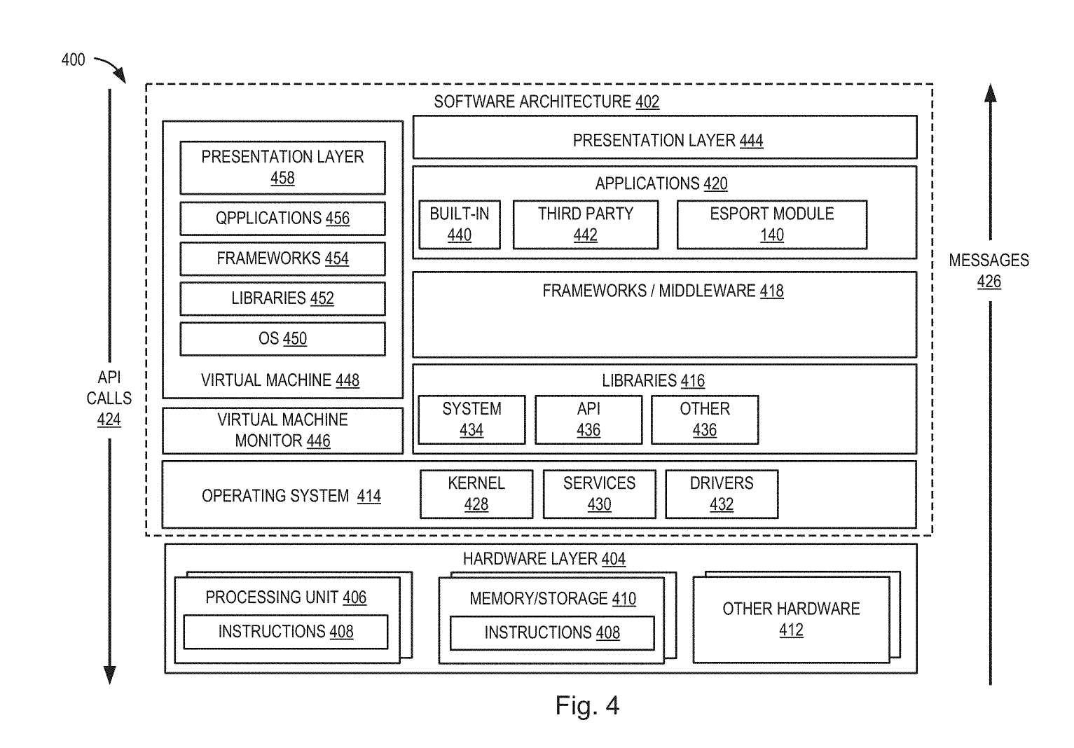

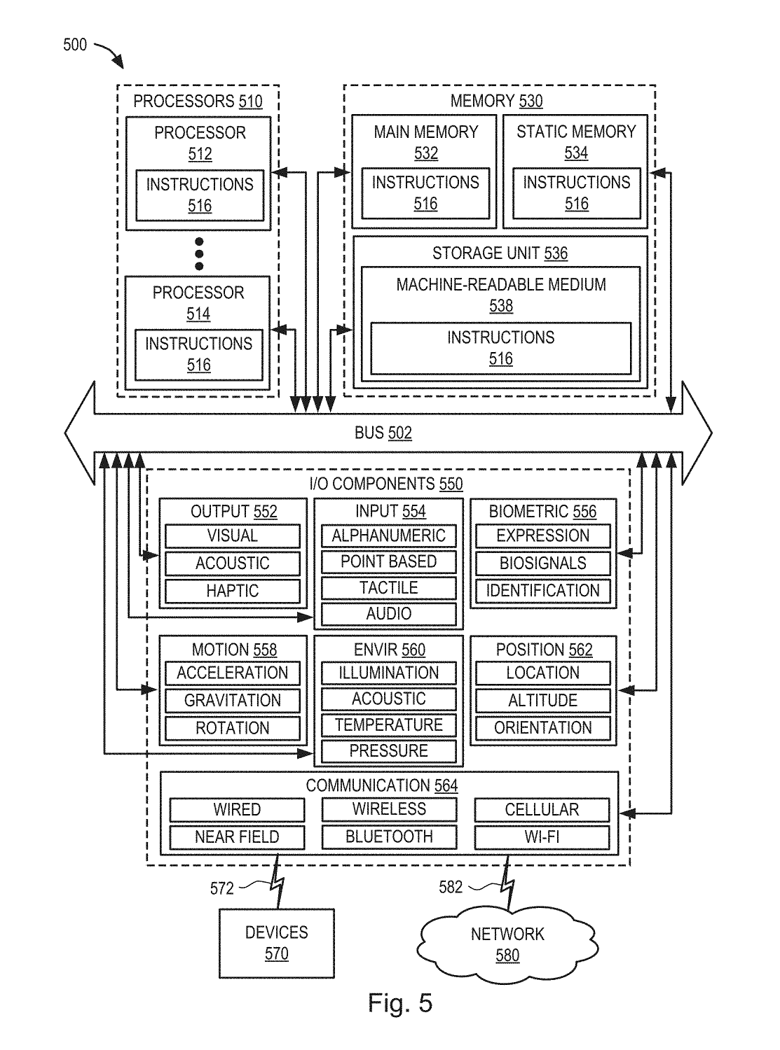

FIG. 4 is a block diagram illustrating an example software architecture 402, which may be used in conjunction with various hardware architectures herein described. FIG. 4 is a non-limiting example of a software architecture and it will be appreciated that many other architectures may be implemented to facilitate the functionality described herein. The software architecture 402 may execute on hardware such as machine 500 of FIG. 5 that includes, among other things, processors 510, memory 530, and input/output (I/O) components 550. A representative hardware layer 404 is illustrated and can represent, for example, the machine 500 of FIG. 5. The representative hardware layer 404 includes a processing unit 406 having associated executable instructions 408. The executable instructions 408 represent the executable instructions of the software architecture 402, including implementation of the methods, modules and so forth described herein. The hardware layer 404 also includes memory and/or storage modules shown as memory/storage 410, which also have the executable instructions 408. The hardware layer 404 may also comprise other hardware 412.

In the example architecture of FIG. 4, the software architecture 402 may be conceptualized as a stack of layers where each layer provides particular functionality. For example, the software architecture 402 may include layers such as an operating system 414, libraries 416, frameworks or middleware 418, applications 420 and a presentation layer 444. Operationally, the applications 420 and/or other components within the layers may invoke application programming interface (API) calls 424 through the software stack and receive a response as messages 426. The layers illustrated are representative in nature and not all software architectures have all layers. For example, some mobile or special purpose operating systems may not provide the frameworks/middleware 418, while others may provide such a layer. Other software architectures may include additional or different layers.

The operating system 414 may manage hardware resources and provide common services. The operating system 414 may include, for example, a kernel 428, services 430, and drivers 432. The kernel 428 may act as an abstraction layer between the hardware and the other software layers. For example, the kernel 428 may be responsible for memory management, processor management (e.g., scheduling), component management, networking, security settings, and so on. The services 430 may provide other common services for the other software layers. The drivers 432 may be responsible for controlling or interfacing with the underlying hardware. For instance, the drivers 432 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 416 may provide a common infrastructure that may be used by the applications 420 and/or other components and/or layers. The libraries 416 typically provide functionality that allows other software modules to perform tasks in an easier fashion than by interfacing directly with the underlying operating system 414 functionality (e.g., kernel 428, services 430, and/or drivers 432). The libraries 416 may include system libraries 434 (e.g., C standard library) that may provide functions such as memory allocation functions, string manipulation functions, mathematic functions, and the like. In addition, the libraries 416 may include API libraries 436 such as media libraries (e.g., libraries to support presentation and manipulation of various media formats such as MPEG4, H.264, MP3, AAC, AMR. JPG, and PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 416 may also include a wide variety of other libraries 438 to provide many other APIs to the applications 420 and other software components/modules.

The frameworks 418 (also sometimes referred to as middleware) provide a higher-level common infrastructure that may be used by the applications 420 and/or other software components/modules. For example, the frameworks/middleware 418 may provide various graphic user interface (GUI) functions, high-level resource management, high-level location services, and so forth. The frameworks/middleware 418 may provide a broad spectrum of other APIs that may be used by the applications 420 and/or other software components/modules, some of which may be specific to a particular operating system or platform.

The applications 420 include built-in applications 440 and/or third-party applications 442. Examples of representative built-in applications 440 may include, but are not limited to, a contacts application, a browser application, a book reader application, a location application, a media application, a messaging application, and/or a game application. The third-party applications 442 may include an application developed using the Android™ or iOS™ software development kit (SDK) by an entity other than the vendor of the particular platform, and may be mobile software running on a mobile operating system such as iOS™, Android™, Windows® Phone, or other mobile operating systems. The third-party applications 442 may invoke the API calls 424 provided by the mobile operating system such as the operating system 414 to facilitate functionality described herein.

The applications 420 may use built-in operating system functions (e.g., kernel 428, services 430, and/or drivers 432), libraries 416, or frameworks/middleware 418 to create user interfaces to interact with users of the system. Alternatively, or additionally, in some systems interactions with a user may occur through a presentation layer, such as the presentation layer 444. In these systems, the application/module “logic” can be separated from the aspects of the application/module that interact with a user.

Some software architectures use virtual machines. In the example of FIG. 4, this is illustrated by a virtual machine 448. The virtual machine 448 creates a software environment where applications/modules can execute as if they were executing on a hardware machine (such as the machine 500 of FIG. 5, for example). The virtual machine 448 is casted by a caster operating system (e.g., operating system 414 in FIG. 4) and typically, although not always, has a virtual machine monitor 446, which manages the operation of the virtual machine 448 as well as the interface with the caster operating system (e.g., operating system 414). A software architecture executes within the virtual machine 448 such as an operating system (OS) 450, libraries 452, frameworks 454, applications 456, and/or a presentation layer 458. These layers of software architecture executing within the virtual machine 448 can be the same as corresponding layers previously described or may be different.

FIG. 5 is a block diagram illustrating components of a machine 500, according to some example embodiments, able to read instructions from a machine-readable medium (e.g., a machine-readable storage medium) and perform any one or more of the methodologies discussed herein. Specifically, FIG. 5 shows a diagrammatic representation of the machine 500 in the example form of a computer system, within which instructions 516 (e.g., software, a program, an application, an applet, an app, or other executable code) for causing the machine 500 to perform any one or more of the methodologies discussed herein may be executed. As such, the instructions 516 may be used to implement modules or components described herein. The instructions 516 transform the general, non-programmed machine 500 into a particular machine 500 programmed to carry out the described and illustrated functions in the manner described. In alternative embodiments, the machine 500 operates as a standalone device or may be coupled (e.g., networked) to other machines. In a networked deployment, the machine 500 may operate in the capacity of a server machine or a client machine in a server-client network environment, or as a peer machine in a peer-to-peer (or distributed) network environment. The machine 500 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 516, sequentially or otherwise, that specify actions to be taken by the machine 500. Further, while only a single machine 500 is illustrated, the term “machine” shall also be taken to include a collection of machines that individually or jointly execute the instructions 516 to perform any one or more of the methodologies discussed herein.

The machine 500 may include processors 510, memory 530, and input/output (I/O) components 550, which may be configured to communicate with each other such as via a bus 502. In an example embodiment, the processors 510 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 512 and a processor 514 that may execute the instructions 516. The term “processor” is intended to include multi-core processor that may comprise two or more independent processors (sometimes referred to as “cores”) that may execute instructions contemporaneously. Although FIG. 5 shows multiple processors, the machine 500 may include a single processor with a single core, a single processor with multiple cores (e.g., a multi-core processor), multiple processors with a single core, multiple processors with multiples cores, or any combination thereof.

The memory 530 may include a memory, such as a main memory 532, a static memory 534, or other memory storage, and a storage unit 536, both accessible to the processors 510 such as via the bus 502. The storage unit 536 and memory 532, 534 store the instructions 516 embodying any one or more of the methodologies or functions described herein. The instructions 516 may also reside, completely or partially, within the memory 532, 534, within the storage unit 536, within at least one of the processors 510 (e.g., within the processor's cache memory), or any suitable combination thereof, during execution thereof by the machine 500. Accordingly, the memory 532, 534, the storage unit 536, and the memory of processors 510 are examples of machine-readable media.

As used herein, “machine-readable medium” means a device able to store instructions and data temporarily or permanently and may include, but is not limited to, random-access memory (RAM), read-only memory (ROM), buffer memory, flash memory, optical media, magnetic media, cache memory, other types of storage (e.g., Erasable Programmable Read-Only Memory (EEPROM)), and/or any suitable combination thereof. The term “machine-readable medium” should be taken to include a single medium or multiple media (e.g., a centralized or distributed database, or associated caches and servers) able to store the instructions 516. The term “machine-readable medium” shall also be taken to include any medium, or combination of multiple media, that is capable of storing instructions (e.g., instructions 516) for execution by a machine (e.g., machine 500), such that the instructions, when executed by one or more processors of the machine 500 (e.g., processors 510), cause the machine 500 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The input/output (I/O) components 550 may include a wide variety of components to receive input, provide output, produce output, transmit information, exchange information, capture measurements, and so on. The specific input/output (I/O) components 550 that are included in a particular machine will depend on the type of machine. For example, portable machines such as mobile phones will likely include a touch input device or other such input mechanisms, while a headless server machine will likely not include such a touch input device. It will be appreciated that the input/output (I/O) components 550 may include many other components that are not shown in FIG. 5. The input/output (I/O) components 550 are grouped according to functionality merely for simplifying the following discussion and the grouping is in no way limiting. In various example embodiments, the input/output (I/O) components 550 may include output components 552 and input components 554. The output components 552 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 554 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and/or force of touches or touch gestures, or other tactile input components), audio input components (e.g., a microphone), and the like.

In further example embodiments, the input/output (I/O) components 550 may include biometric components 556, motion components 558, environment components 560, or position components 562 among a wide array of other components. For example, the biometric components 556 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 558 may include acceleration sensor components (e.g., accelerometer), gravitation sensor components, rotation sensor components (e.g., gyroscope), and so forth. The environmental environment components 560 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 562 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The input/output (I/O) components 550 may include communication components 564 operable to couple the machine 500 to a network 580 or devices 570 via a coupling 582 and a coupling 572 respectively. For example, the communication components 564 may include a network interface component or other suitable device to interface with the network 580. In further examples, communication components 440 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 570 may be another machine or any of a wide variety of peripheral devices (e.g., a peripheral device coupled via a Universal Serial Bus (USB)).

Moreover, the communication components 564 may detect identifiers or include components operable to detect identifiers. For example, the communication components 564 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 564, such as location via Internet Protocol (IP) geolocation, location via Wi-Fi® signal triangulation, location via detecting an NFC beacon signal that may indicate a particular location, and so forth.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A system comprising:
one or more computer processors;
one or more computer memories;
a lifetime value (LTV) module incorporated into the one or more computer memories, the LTV module configuring the one or more computer processors to perform operations for optimizing LTV related to cumulative future rewards for a player of a plurality of computer-implemented games, the operations comprising:
collecting data from a game of the plurality of games, the data including game event data associated with the player, a playing environment within the game, and engine actions performable by the LTV module, the engine actions including advertisement placements and in-app purchase (IAP) placements within the game;
analyzing the data with a first machine-learning (ML) system to create a time-dependent state representation of the game, the player, and the playing environment;
providing the state representation as input to a second ML system to create and optimize an ML policy over time, the ML policy including a functional relationship proposing a selection of one or more of the engine actions to maximize the LTV; and
providing the ML policy and state representation to the LTV optimization module to choose and implement one or more of the engine actions from the proposed selection within the playing environment.

2. The system of claim 1, wherein the first ML system or the second ML system is a recurrent neural network with long short-term memory and gated recurrent units.

3. The system of claim 1, wherein the implementing of the one or more of the engine actions includes placement over time and space of advertisements and IAP purchase options within the playing environment in accordance with the ML policy.

4. The system of claim 1, wherein the playing environment includes one of a 3D virtual environment, a 2D virtual environment, or an augmented reality environment.

5. The system of claim 1, wherein the choosing of the one or more of the engine actions includes using an auction wherein a plurality of advertising entities and IAP entities place one or more bids for placeholder impressions on a promotion platform and the LTV optimization module chooses one of the one or more bids so as to optimize the LTV in accordance with the policy.

6. The system of claim 1, wherein the state representation includes a history of time-ordered game events and context data for the player.

7. The system of claim 1, wherein the game event data includes at least one of device and operating system (OS) information, player gameplay behavior data, application performance data, or game metadata.

8. A method comprising:
performing operations for optimizing LTV related to cumulative future rewards for a player of a plurality of computer-implemented games, the operations comprising:
collecting data from a game of the plurality of games, the data including game event data associated with the player, a playing environment within the game, and engine actions performable by the LTV module, the engine actions including advertisement placements and in-app purchase (TAP) placements within the game;
analyzing the data with a first machine-learning (ML) system to create a time-dependent state representation of the game, the player, and the playing environment;
providing the state representation as input to a second ML system to create and optimize an ML policy over time, the ML policy including a functional relationship proposing a selection of one or more of the engine actions to maximize the LTV; and
providing the ML policy and state representation to the LTV optimization module to choose and implement one or more of the engine actions from the proposed selection within the playing environment.

9. The method of claim 8, wherein the first ML system or the second ML system is a recurrent neural network with long short-term memory and gated recurrent units.

10. The method of claim 8, wherein the implementing of the one or more of the engine actions includes placement over time and space of advertisements and IAP purchase options within the playing environment in accordance with the ML policy.

11. The method of claim 8, wherein the playing environment includes one of a 3D virtual environment, a 2D virtual environment, or an augmented reality environment.

12. The method of claim 8, wherein the choosing of the one or more of the engine actions includes using an auction wherein a plurality of advertising entities and IAP entities place one or more bids for placeholder impressions on a promotion platform and the LTV optimization module chooses one of the one or more bids so as to optimize the LTV in accordance with the policy.

13. The method of claim 8, wherein the state representation includes a history of time-ordered game events and context data for the player.

14. The method of claim 8, wherein the game event data includes at least one of device and operating system (OS) information, player gameplay behavior data, application performance data, or game metadata.

15. A computer-readable storage medium storing a set of instructions, the set of instructions configuring one or more computer processors to perform operations for optimizing LTV related to cumulative future rewards for a player of a plurality of computer-implemented games, the operations comprising:
collecting data from a game of the plurality of games, the data including game event data associated with the player, a playing environment within the game, and engine actions performable by the LTV module, the engine actions including advertisement placements and in-app purchase (IAP) placements within the game;
analyzing the data with a first machine-learning (ML) system to create a time-dependent state representation of the game, the player, and the playing environment;
providing the state representation as input to a second ML system to create and optimize an ML policy over time, the ML policy including a functional relationship proposing a selection of one or more of the engine actions to maximize the LTV; and
providing the ML policy and state representation to the LTV optimization module to choose and implement one or more of the engine actions from the proposed selection within the playing environment.

16. The computer-readable storage medium of claim 15, wherein the first ML system or the second ML system is a recurrent neural network with long short-term memory and gated recurrent units.

17. The computer-readable storage medium of claim 15, wherein the implementing of the one or more of the engine actions includes placement over time and space of advertisements and IAP purchase options within the playing environment in accordance with the ML policy.

18. The computer-readable storage medium of claim 15, wherein the playing environment includes one of a 3D virtual environment, a 2D virtual environment, or an augmented reality environment.

19. The computer-readable storage medium of claim 15, wherein the choosing of the one or more of the engine actions includes using an auction wherein a plurality of advertising entities and IAP entities place one or more bids for placeholder impressions on a promotion platform and the LTV optimization module chooses one of the one or more bids so as to optimize the LTV in accordance with the policy.

20. The computer-readable storage medium of claim 15, wherein the state representation includes a history of time-ordered game events and context data for the player.
